(19) United States
(12) Patent Application Publication
(10) Pub. No.: US 2009/0284431 A1
(43) Pub. Date: Nov. 19, 2009

(54) INTEGRATED ELECTRONICS MATCHING CIRCUIT AT AN ANTENNA FEED POINT FOR ESTABLISHING WIDE BANDWIDTH, LOW VSWR OPERATION, AND METHOD OF DESIGN

(75) Inventors: David E. MEHARRY, Lexington, MA (US); Edward A. URBANIK, Amherst, NH (US); Arturs DINBERGS, Hollis, NH (US)

Correspondence Address: BAE SYSTEMS, PO BOX 868, NASHUA, NH, 03061-0868, US

(73) Assignee: BAE Systems Information and Electronic Systems Intergration Inc., Nashua, NH (US)

(21) Appl. No.: 12/468,109

(22) Filed: May 19, 2009

Related U.S. Application Data
(60) Provisional application No. 61/072,216, filed on May 19, 2008.

(51) Int. Cl. H01Q 1/50; H01Q 9/16; G06F 17/50

(52) U.S. Cl. 343/816; 343/860; 343/822; 343/859; 716/1

(57) ABSTRACT

An integrated electronics matching circuit is placed directly at the feed points of an antenna to match a transmission line to the impedance of the antenna that results in preserving the originally-designed wide bandwidth of the antenna, which in one embodiment is 10:1. A methodology is provided for the design of the integrated electronics matching circuit that marries the output of an antenna modeling tool with an integrated circuit design tool, in which the S parameter outputs of the antenna modeling tool for the antenna ports are coupled to the corresponding ports of the integrated circuit designed by the integrated circuit design tool.

### RELATED APPLICATIONS

This application claims rights under 35 USC § 119(e) from U.S. Application Ser. No. 61/072,216 filed May 19, 2008, the contents of which are incorporated herein by reference.

### FIELD OF THE INVENTION

This invention relates to antenna design and more particularly to an integrated electronics matching circuit embedded at the feed point of the antenna for establishing wide bandwidth and low VSWR for the antenna, and a method for designing the circuit.

### BACKGROUND OF THE INVENTION

The design and the implementation of the electrical feed to an antenna such as a planar dipole or dual orthogonal planar dipoles for multiple polarizations is a critical and often difficult problem, especially for printed antennas intended for high frequency operation.

In the past, complex impedance interfaces to the planar antenna elements were prevalent and were in general placed below the ground plane normally used for such printed circuit antennas.

In the prior art attempts had been made to place transmit and receive amplifiers or even passive networks close to the feed point of the antenna. However, such arrangements were located below the ground plane of the antenna, contained both multiple interfaces and long connection lines to the antenna feed point and utilized non-ideal components. Not only were these arrangements difficult to manufacture they degraded system performance including the noise figure, sensitivity, impedance match, bandwidth, linearity, power and complexity of the antenna system.

There is therefore a need for a simpler feed design which is compatible with surface mount manufacturing technologies and more particularly for a feed design which directly enables the integration of additional electronics at the feed point, thus enabling improved overall performance through the elimination of interfaces, connections and lossy components.

More particularly, the more one removes the feed line end from the feed point of the antenna the more parasitics and other artifacts affect antenna performance, and the more restricted is the bandwidth.

For dipoles or quadrapoles in microwave arrays, and especially for signal intelligence functions which must operate over a wide range of frequencies, it is important to have an efficient coupling system for the antenna feed point to the transmission line so that not only is the VSWR minimized, the bandwidth can be expanded for instance to a 10:1 ratio. In some of the intelligence gathering antenna structures it is necessary for instance to go from 2 gigahertz to 20 gigahertz and still provide efficient coupling of a feed line to an antenna.

Note that at the microwave frequencies involved, the location of the matching circuitry below the ground plane places the end of the feed line as much as a quarter wavelength away from the feed point of the antenna such that there is a transformation that takes place which cannot be resolved with physical elements. If such components as negative length transmission lines or negative inductors were physically realizable for high gigahertz frequencies and broad bandwidths, it would be possible to cope with this problem, but these elements do not exist.

If one is required to place matching circuitry below the ground plane which involves the extra length and extra reactance of the feed structure, according to the Fano's theorem there is a loss of bandwidth in terms of the transformation capability of matching a feed line to the feed point impedance of the antenna.

Thus, the problem with locating antenna tuners or trans-match apparatus below the ground plane results in a significant electrical distance between the end of the feed line and the feed point of the antenna.

If one could provide a matching circuit directly at the feed point of the antenna, one would enable extremely broadband tuning.

However, the problem of locating a tuner or trans-match directly at the feed point of a microwave antenna is that the gigahertz high frequencies compound the problems. This is because operating at these high frequencies implies that one has to build elements which are very tiny and the techniques available to do the matching are not particularly flexible and robust.

For instance, a wavelength at 20 gigahertz is approximately 0.6 inches and in order to provide microwave matching circuitry the physical size of the device has to be much smaller than a wavelength. Thus, in order to effectively provide for a broadband antenna microcircuit dimensions are required.

In the past antenna designers have utilized cut and try techniques to adjust the physical dimensions of the printed dipole, the radiating elements themselves, the length, the width, and sometimes the shape as well as the height of the dipole above the ground plane in order to achieve low VSWR, high bandwidth antenna structures. In some instances antenna designers will insert materials between the radiating dipole and the ground plane ranging from lossy materials to special structures. However, regardless of what is inserted one still has the broadband matching problem because typically one would like to match a 50 ohm transmission line to a 100 to 200 ohm impedance at the feed point of these dipoles.

The trade off when being forced to remove the end of the feed line from the feed point is a reduced bandwidth radiating system. In short, antenna designers trade off bandwidth with match. It is noted that the broader the bandwidth that can be designed by the antenna elements themselves, the more difficult it was to obtain a good match.

Thus, as described above, antenna designers have tried to make a broad bandwidth antenna and match it to a feed line by providing physical changes to the radiating elements. The result is that there are limits to how good a match can be by simply designing the physical attributes of the radiating elements themselves. It requires in some cases very complicated patterns of metal and one still has difficulties in obtaining good antenna performance from the theoretical feed point down through the ground plane where the antenna is connected to real system connections.

Thus, the problem to solve is that of achieving a high degree of match over a very large bandwidth for radiating structures that operate specifically in the microwave range region of the electromagnetic spectrum.

### SUMMARY OF INVENTION

In order to provide a wide bandwidth match, in the subject invention placing an integrated electronics matching circuit at the feed point of the antenna above the ground plane reduces to zero the connection length from the feed line to the place where the matching is done. Thus, the conventional connection length from where the initial or complete matching is done beneath the ground plane up to the antenna feed point is completely eliminated.

In one embodiment, the circuit sizes are less than 100 mils, whereas the feed size itself is on the order of 50 to 100 mils. Thus by placing a miniaturized, integrated circuit at the feed point of the antenna, one is eliminating the distance from the feed point to the end of the transmission line to virtually zero.

The ability to design and fabricate an integrated circuit to be placed at the feed point of the antenna provides a much improved broadband operation. This is because the figure of merit of bandwidth and match is much improved through the elimination of connection length and in some cases parasitic components or structures. It thus will be appreciated that the advantage of having the output of the transmission directly connected to the feed point is very significant.

In order to provide such an integrated circuit, one adds miniaturized components on the monolithic microwave integrated circuits (MMIC) in which the capacitors and inductors are essentially lumped and in which very tiny resistors are utilized which takes advantage of current MMIC technology. Thus, utilizing MMIC technology one can design complex tuning networks that for instance can function as transformers, baluns or utilize active components, all in a sufficiently tiny space to be able to fit between the feed points of the antenna.

Thus, as part of the subject invention is the utilization of a MMIC matching circuit positioned directly at or between the feed points of an antenna.

Another aspect of the subject invention is how to design the integrated circuits themselves. Typically integrated circuit designers utilize integrated circuit design tools which define the circuits in terms of integrated circuit connection ports.

On the other hand, antenna designers utilize electromagnetic 3D finite element analysis or similar tools which it was thought were not particularly useful for real circuit design. Moreover, complex circuit design utilizing the presently available circuit design tools was thought to be totally inadequate for designing antenna radiating structures.

There was therefore a necessity to provide a methodology by which one could design embedded electronic boxes or circuits where each of the physical connections between the electronics and the total design and total antenna structure could be inputted.

The subject system characterizes all of the antenna-related parameters surrounding this embedded electronic circuit so that in the characterization one can have as an output of the electromagnetic analysis a multi-port description of the antenna structures and other parameters outside of the box, where the ports represent the interfaces to the antenna structure.

Having described the antenna in terms of a multi-port interface description, one exports the multi-port description to the integrated circuit design tool so that the integrated circuit design tool supports or enables the design of the integrated circuit that will match the transmission line to the antenna while maintaining wide bandwidth.

From the electromagnetic antenna design point of view, electromagnetic theory was thought not to be applicable to integrated circuit design because electromagnetic theory can't in principle divide up the physical space into sufficiently small 3D cubes or tetrahedra due to the tiny size of the circuit elements that need to be produced. Thus, in general electromagnetic design tools cannot deal with the complexity of the design problem and the size of the design problem rapidly approaches a size that is inconvenient to design or analyze the problem in a single structure. If one wants to approach the problem utilizing a large number of components an excessive amount of computer time is involved. In addition the circuit design needs to allow for the possibility of arbitrary or non-predetermined circuit candidates.

Thus, the method for subdividing the overall structure into small subelements for the electromagnetic design is not adequate for the small sizes of MMIC components. This is because the size of the math problem inside the computer is directly related to the ratio of the size of the overall structure to the size of the tiniest element being analyzed. This problem is too large for current computers.

On the other hand, circuit design tools were thought not to be applicable to antenna design because they do not deal with radiation or electromagnetics in free space, or even what is happening inside the materials.

It is a finding of the subject invention that one can in fact marry electromagnetic antenna design tools with integrated circuit design tools by exercising the electromagnetic analysis tool to provide outputs appropriate for the circuit design tool. Thus, it is part of the subject invention to exercise the electromagnetic tool to provide parameters or outputs that are directly coupled to the circuit design tool.

The problem in marrying these tools was to find a way to cast the electromagnetic problem in a way that the circuit design tool could deal with and vice versa. In addition the electromagnetic problem needed to be cast in a fashion that could support a robust variety of circuit types, consistent with a MMIC based solution. Moreover, one needed to provide simplicity such that instead of having a multi-pass or unconstrained problem, the design would be a one-pass problem where all of the design is accomplished in a single pass.

Again as part of the subject invention, it was found that the S parameter file of the electromagnetic analysis permits the description of the antenna problem in terms of the types of ports that are used in integrated circuit design tools. The S-parameter files are the scattering parameters commonly utilized in microwave technology, which are associated with the waves entering and exiting the circuit ports. These scattering parameters are directly related to the voltages and currents which are present at the circuit ports. Thus, one can have a complete description of a circuit in terms of either its scattering parameters or the associated voltages and currents.

In short, the parameters available from the electromagnetic design tool are the S parameters which are N by N matrices for each frequency involved, where N is the number of circuit ports. In the subject invention one takes the S parameters or scattering parameters in electromagnetic circuit theory which in essence describe the entire antenna and use these S parameters and port theory in the design circuit tools to be able to design a circuit that incorporates the S parameters. By so doing the S parameters fully describe the antenna outside of the aforementioned matching circuit and produce an integrated electronics matching circuit designed using these S parameters that take into account for instance the dipole antenna structure, the ground plane, the feed structure and free space considerations.

While designers normally think of S parameters as being on the periphery of the antenna structure and for the most part on the outside of the structure described, in the subject invention the ports for the S parameters are totally within the matching circuit and therefore inside the antenna structure.

Note that the design principles discussed herein while relating to a simple dipole also relate to linearly polarized dipoles in phased arrays, as well as other types of networks. They also apply to providing switching networks and for instance the transformation between a balanced port connection and a single ended port, such as provide by traditional baluns. It also extends to dual polarization in where for instance the integrated matching circuit is used to switch between two linear polarizations in which the integrated circuit at the feed point of the antenna would contain a switching element. This could be a resistor connected between the horizontal polarization and then switch to the other state where a resistor is provided that is connected to the vertical polarization so that one has well matched properties. However, one is only accessing one of the polarizations at a time. Moreover, it is possible to design the integrated matching circuit at the feed point of the antenna to contain a full network for generating circular polarization from a linearly polarized feed. Finally, the method can be extended to multiple embedded networks.

Thus, the integrated circuit design tool is used to design a matching network that can in one embodiment be a simple four-element lumped element matching network which is then implemented in a 3D electromagnetic analysis tool and analyzed. There is a range of such tools including time or frequency domain finite element methods which are equally appropriate.

In summary, an integrated electronics matching circuit is placed directly at the feed points of an antenna to match a transmission line to the impedance of the antenna that results in preserving the originally-designed wide bandwidth of the antenna, which in one embodiment is 10:1. A methodology is provided for the design of the integrated electronics matching circuit that marries the output of an antenna modeling tool with an integrated circuit design tool, in which the S parameter outputs of the antenna modeling tool for the antenna ports are coupled to the corresponding ports of the integrated circuit designed by the integrated circuit design tool.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of prior art antenna feed circuitry in which an antenna feed line matching network is located beneath the ground plane of a dipole antenna by up to a quarter of a wavelength, and incorporating a complicated feed structure for the antenna;

FIG. 2 is a diagrammatic illustration of an integrated electronics matching circuit placed at the feed point of an antenna and above the associated ground plane;

FIG. 3 is a diagrammatic illustration of a dipole with an integrated electronics matching circuit located at the feed point of the dipole with, the integrated electronics matching circuit used to match the feed line to the antenna feed point;

FIG. 4 is a schematic diagram of the integrated electronics matching circuit of FIG. 3 showing the capacitive and inductive elements of the matching circuit;

FIG. 5 is a diagrammatic illustration of the characterization of the antenna, ground plane, feed and free space using a 3D finite element analysis tool in which S parameter ports from the 3D finite element analysis tool are used by an integrated circuit design tool for the generation of an integrated circuit network that performs the required matching function; and,

FIG. 6 is a flow chart showing the utilization of an electromagnetic design 3D finite element analysis tool to generate scattering parameters that are employed by an integrated circuit design tool.

### DETAILED DESCRIPTION

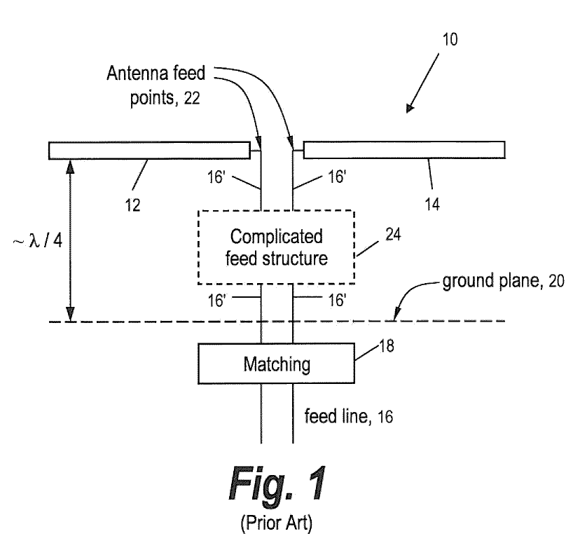

Referring now to FIG. 1, in the prior art an antenna here pictured as a dipole 10 having dipole elements 12 and 14 is to be connected to a feed line 16, with the feed line to be matched to the antenna. In the past, in order to accomplish this a matching circuit 18 was located below the ground plane 20 for antenna 10. This located the matching circuit oftentimes a quarter of a wavelength away from the antenna feed points 22 of antenna 10.

In the past, complex impedance interfaces to planar antenna elements placed below the ground plane involved long connection lines to the antenna feed point and used non-ideal components. These long connection lines, here illustrated at 16′, introduce parasatics and artifacts which in turn restrict antenna bandwidth.

As mentioned above, it is important to have an efficient coupling system for the antenna feed point to the transmission line to minimize VSWR problems and to be able to provide a wide bandwidth for the antenna. When the end of the feed line is located as much as a quarter wavelength away from the feed point of the antenna there is a transformation that takes place which cannot be resolved with physical elements. While those in the past have suggested physically complex structures to counteract the transformation such as illustrated in dotted box 24, this also results in unresolved complications and performance restrictions. Other attempts to resolve the problem of the transformation associated with having a considerable distant between the end of the feed line and the antenna feed point have centered around complicated antenna geometries in which the antenna elements have their physical dimensions altered as well as their shape. As a result, up to the present time it was only with difficulty that matching to printed circuit antennas could be achieved along with a wide broadband response.

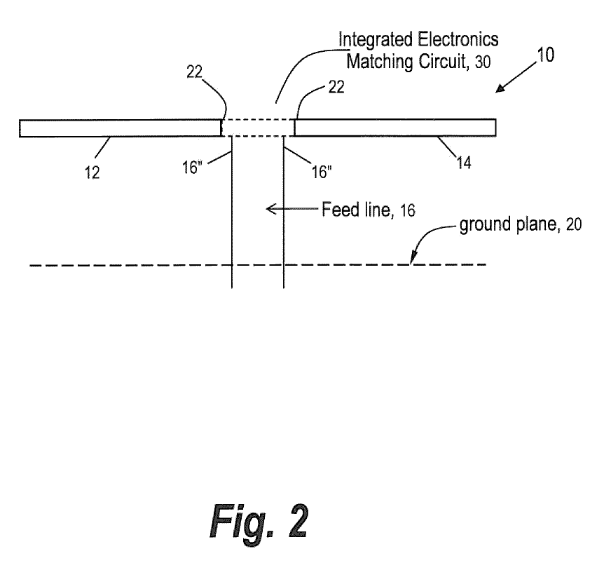

Referring now to FIG. 2, antenna 10 with elements 12 and 14 are provided with an integrated electronics matching circuit 30 that is located at the feed point of the antenna. This feed point is either the physical feed point of the antenna or the electrical feed point of the antenna, or both. The point here is that the integrated electronics matching circuit is not separated from the feed point 22, but rather exists above the ground plane for the antenna. As illustrated here, feed line 16 extends up through ground plane 20 where it is coupled to the integrated electronics matching circuit 30 at the ends 16″ of feed line 16. (Note that 16″ does not have to be close to 22 as long as the distance is part of the 3D electromagnetic analysis.)

The result is that the transformation that was taking place when the matching circuit was below the ground plane does not occur. This in turn means that with appropriate matching the bandwidth of the antenna can be as wide as 10:1.

With circuit sizes for the integrated electronics matching circuit being on the order of 100 mils, placing a miniaturized integrated circuit at the feed point of the antenna eliminates the distance from the feed point to the end of the transmission line to virtually zero.

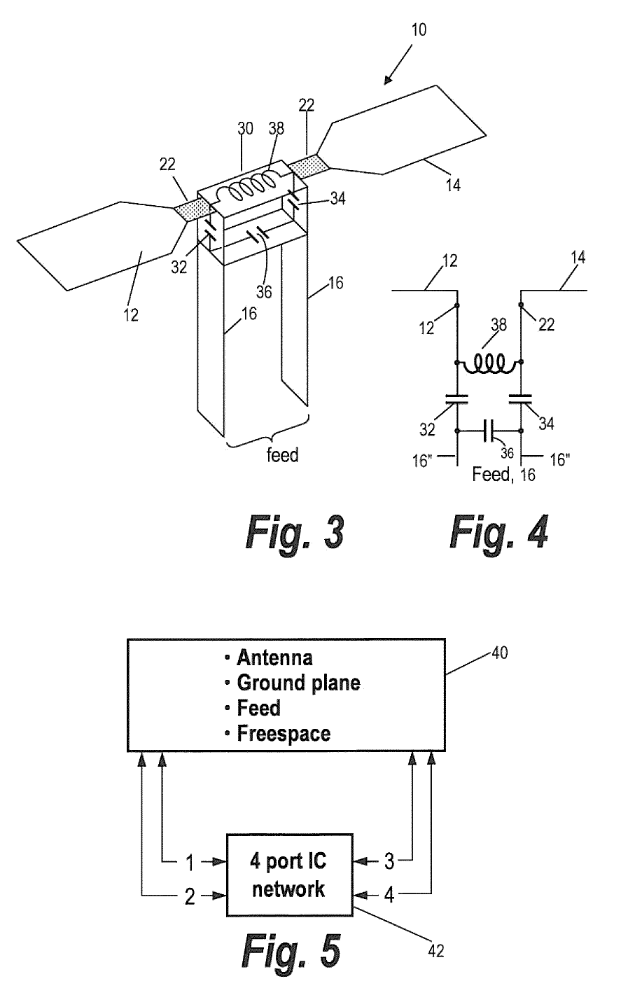

Referring to FIG. 3, antenna 10 is shown with patterned elements 12 and 14 having shaded feed points 22 coupled to an integrated electronics matching circuit 30 to which feed lines 16 are coupled.

In one embodiment, the integrated electronics matching circuit includes monolithic microwave integrated circuit capacitors 32, 34 and 36 and inductor 38.

The schematic for the circuit diagram for the integrated electronics matching circuit is shown in FIG. 4. Here, the matching circuit is coupled between the end 16″ of feed line 16 and antenna feed points 22.

It is noted that in monolithic microwave integrated circuits capacitors and inductors are essentially lumped and for instance can contain very tiny resistors. This monolithic microwave integrated circuit technology permits designing complex tuning circuits that can for instance function as transformers, baluns, or active components, all in a sufficiently small space to fit between the feed points of the printed circuit antenna.

### Design Methodology

A part of the subject invention is the ability to design the appropriate integrated electronics matching circuit for a predetermined antenna. The subject invention thus includes a method of designing this integrated electronics matching circuit by marrying the output of an electromagnetic 3D finite element analysis tool to an integrated circuit design tool.

As shown in FIG. 5, the antenna and its electromagnetic structure can be characterized in a 3D finite element analysis tool here shown at 40 to include the antenna parameters, ground plane parameters, feed structure parameters and free space considerations.

One output of such a 3D finite element analysis tool is the so-called S parameters or scattering parameters, which are the result of electromagnetic analysis. The S parameters comprise a multi-port description of the antenna structure and other parameters, where the ports represent the interfaces to the antenna structure.

The information at these ports is employed by an integrated circuit design tool 42 which in the illustrated embodiment is used to design a four port IC network corresponding to the network shown in FIG. 4.

Thus in the subject invention, the S parameter file from the electromagnetic analysis tool permits the description and operation of the antenna to be imported into the integrated circuit design tool in terms of ports. Note, a port in the 3D finite element analysis tool is connected to a corresponding circuit port in the integrated circuit design tool to marry the two tools. Thus, for instance an antenna port corresponding to an antenna feed point is connected to the circuit port that is to be connected to this feed point. As a result, all of the circuit ports are connected to the corresponding antenna ports and vice versa. Inherent in the operation of the circuit design tool is the ability to deal correctly with the electromagnetic 3D finite element analysis tool output.

As mentioned before, the S parameter files are the scattering parameters commonly utilized in microwave technology which are associated with waves entering and exiting the circuit ports. It is noted that these scattering parameters are directly related to the voltages and currents which are present at the circuit ports such that one has a complete description of the circuit in terms of either its scattering parameters or the associated voltages and currents.

In one embodiment, the subject method begins with a design and configuration of the antenna for finite element analysis. Small ports, commonly called “lumped ports,” are placed internally at the location of the planned interconnections. Analysis of this structure provides a multi-port output file that can be exported to the circuit analysis tool for further validation. Next, reference configurations are analyzed in which the lumped ports are replaced by 50 ohm resistors, short circuits, open circuits and additional interconnected configurations. The integrated circuit design tool schematic can be used for comparing the input impedance behavior of the configurations with different reference terminations. The results of the circuit analysis are compared to the electromagnetic analysis. Next a simple matching network comprised of three capacitors and one inductor is designed. This network is also compared to the electromagnetic analysis, validating the design.

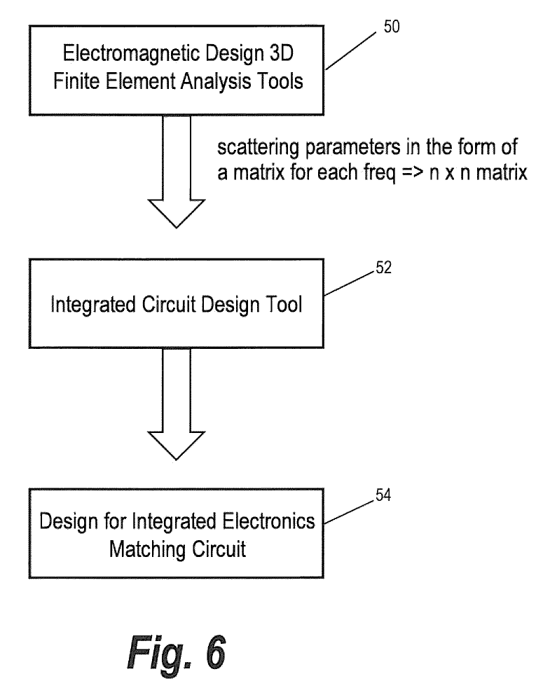

Referring to FIG. 6, from a flow chart point of view, an electromagnetic design 3D finite element analysis tool 50 provides scattering parameters in the form of an n×n matrix for each frequency which are incorporated in an integrated circuit design tool 52 that utilizes this characterization of the antenna in the design of the integrated circuit to be placed at the feed point of the antenna. The result as illustrated at 54 is the design of the integrated electronics matching circuit appropriate for the antenna.

More particularly, a circuit design tool such as Microwave Office (trademark of Applied Wave Research, Inc.), which operates on a windows based personal computer, has broad and flexible capabilities for supporting the design of a range of circuits, including Monolithic Microwave Integrated Circuits (MMICs). The internal workings of the software operate on voltages and currents present at a large number of internal connections (nodes) of resistors, capacitors, inductors, transmission lines, batteries and other idealized components. Information about the overall behavior and performance of this circuitry can be derived from the voltages and currents appearing at the nodes which are at the external connections to the circuitry. In microwave circuits these nodes/connections are often called ports. One representation of the circuit performance can be a matrix, where each entry of the matrix gives the relationship between a corresponding voltage and current at the ports. Each of the matrix entries is also a function of frequency (or time). Common types of matrix are the impedance (Z) and admittance (Y) matrix. A representation which is very convenient for microwave circuits is the scattering (S) matrix. In this case the port also has an associated termination impedance, frequently 50 ohms, and the incident and reflected power are represented by the S-matrix. Each entry of the matrix is an S-parameter. There are well known formulas to enable calculation of the power flowing into and out of each port (hence s-parameters) based on the voltages and currents at the ports, and the termination impedance connected to that port. The physical size of a port is typically much smaller than a wavelength at any frequency under consideration. This is important when connecting to radiating structures such as antennas, which are much “larger”.

Circuits or entities of greater complexity can be designed and analyzed by operating on the Y or S parameters of subcircuits, using the capabilities within the circuit design tool. The S- (or Y-) parameters of a subcircuit in these cases would be a matrix with an entry for each combination of input and output parameter, at each frequency under consideration.

The Y- or S-parameters of a potential subcircuit can also be obtained by measurement or calculation from another design tool. In this case the matrix would be imported as a file into the circuit design tool and treated the same as a subcircuit which was calculated from the basic resistor, capacitor, or inductive elements.

A class of design tools of particular interest to antenna design calculates the electromagnetic fields in small chunks of space, meaning smaller than a wavelength at the frequency of calculation. These chunks are typically rectangular or triangular boxes. A common method, used by HFSS (High Frequency Structure Simulator, by Ansoft, Inc.) is based on the 3-dimensional finite element method of calculation. This method calculates the electric and magnetic fields at the interface between each tiny box, and uses matrix arithmetic, just like the circuit simulator, to find an overall solution. The solution can be portrayed by the fields or currents at each of the boxes over space. It is also possible to calculate the S-parameters at appropriately defined ports inside, or more typically, at the periphery of the calculation space. The S-parameter matrix file are then exported for use in the above described circuit analysis tool.

In the following description of the design flow, MWO represents the circuit design tool, and HFSS the electromagnetic field antenna design tool.

### Method:

An antenna element is selected, such as a single dipole inside of a large phased array. The case of crossed dipoles for dual-polarization is an extension of this case. The design problem is set up for application to analysis by HFSS. A single dipole can be examined using rules in HFSS for repeated or periodic structures.

The trial geometry of the element is determined. This will provide the parameters used ill the HFSS analysis. These design parameters will be:

The length, width, thickness, and shape of the dipole

The height of the dipole over a ground plane

The composition of the material between the radiating element (dipole) and the ground plane, typically a dielectric material such as duroid.

The composition of the material above the radiating element, such as a radome

Proximity to adjacent elements and any provision for coupling between elements

Sufficient height above the dipole radiating element for accurate calculation of radiated fields

Provision for connecting to the dipole. In the simplest case this will consist of an ideal feed (internal port) right at the middle of the dipole. In more complicated cases a feed structure is also analyzed. Additional parameters would be needed to describe the location and dimensions of this feed structure. The connection port in this case would probably be at the ground plane where the feed structure intersects it.

Up to this point the methodology is standard for antenna design, Any required matching circuitry would be placed at the feed below the ground plane. This matching circuitry is also conventionally a two port circuit. These ports may be either balanced or unbalanced. The circuit tool would be appropriate for designing the matching circuit based on using the s-parameters of the resulting analysis up to this point. The results would probably show that it is very difficult to get the desired match characteristics with easily realized matching circuitry (this means fabricated using components with reasonable values).

Understanding that a better match can be obtained (providing better antenna efficiency, etc.) by reducing the distance between the matching circuit and the item to be matched, a location is identified within the antenna structure where it may be convenient to fabricate this improved matching network. Because the ground plane location is the closest point outside the structure, the matching network must be inside the antenna structure.

In one embodiment, this location typically encompasses the region where the feed structure connects to the middle of the dipole. This region that houses the subject integrated circuit matching module should be fairly small. Ports must also be located on the surface of the matching module. These ports become the points of interconnection for the resulting matching network that will be designed at the end of this process.

As illustrated in FIG. 5 in the above example there is a port for connections between:
1. One node of the matching network and one dipole arm
2. A second node of the matching network and the second dipole arm
3. A third node of the matching network and one connection point of the balanced feed
4. A fourth node of the matching network and the other connection point of the balanced feed.

Each node is represented by a port in the ensuing HFSS analysis and the MWO design of the matching network.

There may be additional ports in the analysis. It will be appreciated that a fifth port, corresponding to the feed structure connection at the ground plane, can be provided to measure VSWR and check the trial integrated circuit configuration and verify its match and other functional behavior. It is also possible to include more than one embedded structure or circuit, incorporating additional ports in an analogous manner, as well as ports representing the various modes of radiation from the antenna. It can also be useful to include a local ground reference through the placement of a conducting pad to which the ports or components can be attached. This facilitates calculations used to validate the configuration and choice of geometry for the embedded box.

At this point the HFSS analysis is carried out with results presented in the form of a 5-port set of S-parameters (S-parameter matrix). This analysis is not directly useful in any other fashion. No meaningful radiation patterns can be obtained. Any VSWR characterization would not show antenna performance. Efficiency would be irrelevant.

However the 5-port s-parameter matrix file is imported into MWO.

First consider a simple case in which there is no matching network at all, just conventional direct connection.

In MWO, make a direct connection between 1 and 3. Make a second direct connection between 2 and 4.

Calculate the VSWR looking into port 5. This will be the VSWR that HFSS would calculate at the same location with no matching network.

Now design a matching network.

In the example cited the subject system is utilized to retune the frequency of best match from 14 GHz to 7 GHz. This is determined from calculation of the port 5 match when the matching network is put in place. The connections between the matching network and the antenna structure are as described above and which are also in the example. The matching network must have four connection points (nodes or ports).

The starting point is usually an arrangement of balanced (symmetrically placed) inductors and capacitors in T- or pi- or ladder groupings. Using various methods common to circuit designers in the design of matching networks, a matching topology is obtained. The methods could range from synthesis to trial and error, but are not critical here. In general there could be a very large number of components, not limited to just inductors and capacitors. During a typical matching circuit design, a large variety of circuit configurations is examined, and an even larger variety of detailed element values is tried. In the example cited, a group of 3 capacitors and 1 inductor was found that retuned this particular dipole from 14 to 7 GHz. This is determined through calculation of the port 5 match (return loss or VSWR).

To complete the design, a second HFSS analysis was done in which the matching circuit was placed into the antenna at the predefined connection points. Subsequent analysis and calculation of the input match was substantially identical to the result obtained in MWO. This final calculation in HFSS took much, much longer than the corresponding case in MWO.

In the above what is also described is a case where a set of switches could be alternately connected and disconnected between the matching network and the antenna network, allowing reconfiguration of the antenna between two frequencies.

It is part of the subject invention that the integrated electronics matching circuit may include a single matching network or multiple embedded networks. The integrated electronics matching circuit can include not only passive elements such as a capacitor, resistor and inductor, but also includes active elements, which in one embodiment may be used for polarization selection. Also, the integrated electronics matching circuit may include variable tuning elements as well as balun elements which convert a balanced network to an unbalanced network, as well as an unbalanced network to a balanced network.

Additionally, and as mentioned above, the active elements of the integrated electronics matching circuit can function as an amplifier, limiter or a switch, whereas the components can also include a transmission line or any microwave passive component. It is part of the subject invention that all of the above components are part of a monolithic microwave integrated circuit that functions as a matching circuit; and that all the components may be manufactured by microwave monolithic integrated circuit fabrication techniques.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for matching a feed line to an antenna located above a ground plane comprising:
an antenna having feed points;
an integrated electronics matching circuit positioned at said feed points; and,
a feed line running through said ground plane and having an end connected to said integrated electronics matching circuit.

2. The apparatus of claim 1, wherein the distance between the end of said feed line and said feed points is less than a quarter of a wavelength of the frequency at which said antenna is operated.

3. The apparatus of claim 1, wherein the size of said integrated electronics matching circuit is commensurate with sizes associated with miniaturized integrated circuits.

4. The apparatus of claim 3, wherein said size is consistent with the size of a monolithic microwave circuit.

5. The apparatus of claim 4, wherein said size is on the order of 100 mils.

6. The apparatus of claim 1, wherein said integrated electronics matching circuit includes a single matching network.

7. The apparatus of claim 1, wherein said integrated electronics matching circuit includes multiple embedded networks.

8. The apparatus of claim 1, wherein said antenna includes a single dipole.

9. The apparatus of claim 1, wherein said antenna includes multiple dipoles.

10. The apparatus of claim 9, wherein at least two of said multiple dipoles are crossed.

11. The apparatus of claim 1, wherein said antenna includes patch radiators.

12. The apparatus of claim 1, wherein said integrated electronics matching circuit includes active elements.

13. The apparatus of claim 12, wherein said active elements are used for polarization selection.

14. The apparatus of claim 1, wherein said integrated electronics matching circuit includes variable tuning elements.

15. The apparatus of claim 1, wherein said integrated electronics matching circuit includes elements which convert a balanced network to an unbalanced network.

16. The apparatus of claim 1, wherein said integrated electronics matching circuit includes elements to convert an unbalanced network to a balanced network.

17. The apparatus of claim 1, wherein said integrated electronics matching circuit includes active components that function as one of an amplifier, a limiter, or a switch.

18. A method of feeding an antenna so as to preserve an originally designed wide bandwidth, comprising the steps of:
connecting an integrated electronics matching circuit directly to the feed points of the antenna; and,
coupling a feed line to the integrated electronics matching circuit, whereby the wide bandwidth performance of the antenna is not deleteriously affected by the distance between the end of the feed line and feed points of the antenna, the distance being virtually zero due to the placement of the integrated electronics matching circuit at the feed points of the antenna.

19. The method of claim 18, and further including the step of limiting the size of the integrated electronics matching circuit to fit between the feed points of the antenna.

20. The method of claim 19, wherein the integrated electronics matching circuit includes a monolithic microwave integrated circuit.

21. The method of claim 20, wherein the monolithic microwave integrated circuit includes at least one of a capacitor and an inductor.

22. The method of claim 20, wherein the monolithic microwave integrated circuit includes at least one of a capacitor and a resistor.

23. The method of claim 20, wherein the monolithic microwave integrated circuit includes an active element.

24. The method of claim 23, wherein the active element is selected from the group consisting of a switch, limiter and an amplifier.

25. The method of claim 20, wherein the monolithic microwave integrated circuit includes one of a transmission line and a microwave passive component.

26. A method for designing an antenna and a feed line therefor matched to the antenna feed points comprising the steps of:
utilizing an antenna design tool to model an antenna and to provide scattering parameters therefor in the form of a matrix for each frequency at which the antenna is to operate;
exporting the scattering parameters from the antenna design tool to an integrated circuit design tool; and,
exercising the integrated circuit design tool to design an integrated electronics matching circuit based on the scattering parameters from the antenna design tool.

27. The method of claim 26, wherein the scattering parameters are available as an output from the design tool as a function of external antenna ports, and wherein the scattering parameters available at the ports are coupled to ports associated with the matching circuit designed by the integrated circuit design tool.
